(19) United States
(12) Patent Application Publication
(10) Pub. No.: US 2009/0216447 A1
(43) Pub. Date: Aug. 27, 2009

(54) POSITION CALCULATION METHOD AND POSITION CALCULATION SYSTEM

(75) Inventor: Shuji UCHIDA, Shiojiri (JP)

Correspondence Address: GLOBAL IP COUNSELORS, LLP, 1233 20TH STREET, NW, SUITE 700, WASHINGTON, DC, 20036-2680, US

(73) Assignee: SEIKO EPSON CORPORATION, Tokyo (JP)

(21) Appl. No.: 12/391,603

(22) Filed: Feb. 24, 2009

(30) Foreign Application Priority Data
Feb. 26, 2008 (JP) 2008-044605

(51) Int. Cl. G01C 21/00

(52) U.S. Cl. 701/213; 701/207

(57) ABSTRACT

A position calculation method includes storing navigation data at a given reference date as reference navigation data corresponding to the reference date, transmitting the reference date to request a server that provides navigation data to transmit latest differential navigation data that indicates a difference between the navigation data at the reference date and latest navigation data, receiving the latest differential navigation data from the server, and calculating a position by performing given positioning calculations based on the latest differential navigation data received from the server and the reference navigation data.

Japanese Patent Application No. 2008-44605 filed on Feb. 26, 2008, is hereby incorporated by reference in its entirety.

### BACKGROUND

The present invention relates to a position calculation method and a position calculation system.

The global positioning system (GPS) has been widely known as a positioning system that utilizes a satellite. The GPS has been utilized for a position calculation device provided in a portable telephone, a car navigation system, or the like. A GPS position calculation device calculates its position by calculating four parameters (i.e., three-dimensional coordinate values that indicate the position of the GPS positioning device and a clock error) based on information such as the positions of a plurality of GPS satellites and the pseudo-range between each GPS satellite and the GPS positioning device (i.e., positioning calculations).

The GPS position calculation process includes calculating GPS satellite information (e.g., position, speed, and moving direction) based on navigation data superimposed on a GPS satellite signal transmitted from a GPS satellite, and performing positioning calculations using the satellite information and the time information (see U.S. Pat. No. 6,944,541, for example). The navigation data includes almanac data that indicates approximate orbit information of all GPS satellites, ephemeris data that indicates precise orbit information of each GPS satellite, and the like.

The navigation data that includes the almanac data, the ephemeris data, and the like contains 25 frames. Since the frame cycle is 30 seconds, it takes 12.5 minutes to receive the entire navigation data. The ephemeris data (i.e., information of the satellite that transmits the satellite signal) is included in each frame. Therefore, the ephemeris data can be received within the frame cycle time (30 seconds). The ephemeris data includes various types of information (e.g., epoch time, clock correction value, mean anomaly, right ascension of the ascending node, and argument of perigee) relating to the GPS satellite.

Detailed satellite position information specified in the navigation data (particularly the ephemeris data) is indispensable for positioning calculations. Therefore, when starting positioning calculations in the absence of the ephemeris data, the position cannot be calculated until the ephemeris data is acquired. As a result, the Time To First Fix (TTFF) increases.

The ephemeris data is also important when acquiring a satellite. Therefore, it takes time to acquire a satellite when starting positioning calculations in the absence of the ephemeris data. This also results in an increase in TTFF. Even if the position has been calculated, the period of time required to acquire another satellite varies to a large extent depending on whether or not the ephemeris data has been acquired.

### SUMMARY

According to one aspect of the invention, there is provided a position calculation method implemented by a position calculation system that includes a position calculation device and a server, the position calculation device calculating its position by performing given positioning calculations based on navigation data that is positioning satellite orbit information, and the server providing navigation data to the position calculation device, the position calculation method comprising:

causing the position calculation device to store navigation data at a given reference date as reference navigation data corresponding to the reference date, transmit the reference date to the server to request the server to transmit latest differential navigation data that indicates a difference between the navigation data at the reference date and latest navigation data, receive the latest differential navigation data from the server, and calculate its position by performing the given positioning calculations based on the latest differential navigation data received from the server and the reference navigation data; and

causing the server to successively acquire latest navigation data from a positioning satellite or an external system, store the acquired navigation data, generate the latest differential navigation data based on navigation data at the reference date transmitted from the position calculation device and the latest navigation data included in the stored navigation data, and transmit the generated latest differential navigation data to the position calculation device.

According to another aspect of the invention, there is provided a position calculation system comprising:

a position calculation device that calculates its position by performing given positioning calculations based on navigation data that is positioning satellite orbit information; and

a server that provides navigation data to the position calculation device,

the position calculation device including:

a storage section that stores navigation data at a given reference date as reference navigation data corresponding to the reference date;

a differential navigation data request section that transmits the reference date to the server to request the server to transmit latest differential navigation data that indicates a difference between the navigation data at the reference date and latest navigation data;

a reception section that receives the latest differential navigation data from the server; and

a position calculation section that calculates the position of the position calculation device by performing the given positioning calculations based on the latest differential navigation data received from the server and the reference navigation data; and

the server including:

a navigation data acquisition section that successively acquires latest navigation data from a positioning satellite or an external system;

a storage section that stores the acquired navigation data;

a latest differential navigation data generation section that generates the latest differential navigation data based on navigation data at the reference date transmitted from the position calculation device and the latest navigation data included in the stored navigation data; and

a transmission section that transmits the generated latest differential navigation data to the position calculation device.

### BRIEF DESCRIPTION OF THE DRAWINGS

FIG. 1 is a view showing a schematic configuration of a position calculation system.

FIG. 2 is a view illustrative of the ephemeris data supply principle.

FIG. 3 is a block diagram showing the functional configuration of a portable telephone.

FIG. 4 is a view showing an example of data stored in a ROM of a portable telephone.

FIG. 5 is a view showing an example of data stored in a flash ROM of a portable telephone.

FIG. 6 is a view showing an example of data stored in a RAM of a portable telephone.

FIG. 7 is a view showing an example of the data configuration of a terminal ephemeris database.

FIG. 8 is a flowchart showing the flow of a first position calculation process.

FIG. 9 is a flowchart showing the flow of a first ephemeris request process.

FIG. 10 is a block diagram showing the functional configuration of a server.

FIG. 11 is a view showing an example of data stored in a ROM of a server.

FIG. 12 is a view showing an example of data stored in a hard disk of a server.

FIG. 13 is a view showing an example of the data configuration of a base station ephemeris database.

FIG. 14 is a flowchart showing the flow of a first ephemeris supply process.

FIG. 15 is a flowchart showing the flow of a second position calculation process.

FIG. 16 is a flowchart showing the flow of a second ephemeris request process.

FIG. 17 is a flowchart showing the flow of a second ephemeris supply process.

FIG. 18 is a flowchart showing the flow of a third ephemeris request process.

### DESCRIPTION OF EXEMPLARY EMBODIMENTS

Several embodiments of the invention may enable quick acquisition of navigation data.

According to one embodiment of the invention, there is provided a position calculation method implemented by a position calculation system that includes a position calculation device and a server, the position calculation device calculating its position by performing given positioning calculations based on navigation data that is positioning satellite orbit information, and the server providing navigation data to the position calculation device, the position calculation method comprising:

causing the position calculation device to store navigation data at a given reference date as reference navigation data corresponding to the reference date, transmit the reference date to the server to request the server to transmit latest differential navigation data that indicates a difference between the navigation data at the reference date and latest navigation data, receive the latest differential navigation data from the server, and calculate its position by performing the given positioning calculations based on the latest differential navigation data received from the server and the reference navigation data; and

causing the server to successively acquire latest navigation data from a positioning satellite or an external system, store the acquired navigation data, generate the latest differential navigation data based on navigation data at the reference date transmitted from the position calculation device and the latest navigation data included in the stored navigation data, and transmit the generated latest differential navigation data to the position calculation device.

According to another embodiment of the invention, there is provided a position calculation system comprising:

a position calculation device that calculates its position by performing given positioning calculations based on navigation data that is positioning satellite orbit information; and

a server that provides navigation data to the position calculation device,

the position calculation device including:

a storage section that stores navigation data at a given reference date as reference navigation data corresponding to the reference date;

a differential navigation data request section that transmits the reference date to the server to request the server to transmit latest differential navigation data that indicates a difference between the navigation data at the reference date and latest navigation data;

a reception section that receives the latest differential navigation data from the server; and

a position calculation section that calculates the position of the position calculation device by performing the given positioning calculations based on the latest differential navigation data received from the server and the reference navigation data; and

the server including:

a navigation data acquisition section that successively acquires latest navigation data from a positioning satellite or an external system;

a storage section that stores the acquired navigation data;

a latest differential navigation data generation section that generates the latest differential navigation data based on navigation data at the reference date transmitted from the position calculation device and the latest navigation data included in the stored navigation data; and

a transmission section that transmits the generated latest differential navigation data to the position calculation device.

According to the above configuration, the position calculation device requests the server to transmit the latest differential navigation data that indicates the difference between the navigation data at the given reference date and the latest navigation data. The server that has received the request generates the latest differential navigation data using the navigation data that has been acquired from the positioning satellite or the external system, based on the navigation data at the reference date transmitted from the position calculation device and the latest navigation data, and transmits the latest differential navigation data to the position calculation device. The position calculation device calculates its position by performing the given positioning calculations based on the latest differential navigation data received from the server and the reference navigation data stored in the position calculation device.

Since the latest differential navigation data is indicated by the difference between the navigation data at the reference date and the latest navigation data, the amount of the latest differential navigation data is smaller than that of the latest navigation data. Moreover, since the position calculation device can receive the data from server by a data transmission-specific communication method, differing from a position calculation signal method (e.g., positioning satellite signal), the period of time required to transmit and receive the latest differential navigation data is significantly reduced as compared with the period of time required to acquire the latest navigation data through a satellite signal. Since the position calculation device acquires the navigation data from the server, the position calculation device can reliably acquire the navigation data without being affected by the environment.

According to another embodiment of the invention, there is provided a position calculation method comprising:

storing navigation data at a given reference date as reference navigation data corresponding to the reference date;

transmitting the reference date to a server that provides navigation data to request the server to transmit latest differential navigation data that indicates a difference between the navigation data at the reference date and latest navigation data;

receiving the latest differential navigation data from the server; and

calculating a position by performing given positioning calculations based on the latest differential navigation data received from the server and the reference navigation data.

According to the above configuration, the server is requested to transmit the latest differential navigation data that indicates the difference between the navigation data at the reference date and the latest navigation data, and a position is calculated by performing given positioning calculations based on the latest differential navigation data received from the server and the stored reference navigation data. In this case, the same effects as in the above embodiments can be achieved.

The position calculation method may further comprise:

requesting the server to transmit navigation data at a current date by transmitting the current date to the server; and

updating the stored reference navigation data with navigation data transmitted from the server in response to the request that requests the latest navigation data, and updating the reference date corresponding to the reference navigation data with the current date.

According to the above configuration, the current date is transmitted to the server to request the server to transmit the navigation data at the current date. The stored reference navigation data is updated with the navigation data transmitted from the server in response to the request, and the reference date corresponding to the reference navigation data is updated with the current date.

The position calculation method may further comprise:

determining whether or not a time difference between the reference date of the stored reference navigation data and the current date has exceeded a given time,

the requesting including requesting the server to transmit the navigation data at the current date when it has been determined that the time difference has exceeded the given time.

According to the above configuration, the server is requested to transmit the navigation data at the current date when the time difference between the reference date and the current date has exceeded the given time. Therefore, when the reference navigation data is old, the reference navigation data can be updated with the latest data by acquiring the navigation data at the current date from the server.

In the position calculation method,

the server may include a navigation data prediction section that predicts navigation data corresponding to a given prediction period, and a predicted differential navigation data calculation section that calculates predicted differential navigation data that indicates a difference between the navigation data predicted by the navigation data prediction section and navigation data at a reference date transmitted from a position calculation device;

the storing may include storing the predicted differential navigation data corresponding to the prediction period of the predicted differential navigation data;

the method may further comprise determining whether or not navigation data or predicted differential navigation data at a current date is stored;

the requesting may include transmitting the current date to the server to request the server to transmit the latest differential navigation data and predicted differential navigation data corresponding to the prediction period when it has been determined that navigation data or predicted differential navigation data corresponding to the current date is not stored; and

the method may further comprise storing the latest differential navigation data and the predicted differential navigation data transmitted from the server in response to the request when it has been determined that navigation data or predicted differential navigation data corresponding to the current date is not stored.

According to the above configuration, the server predicts the navigation data corresponding to the given prediction period, and calculates the predicted differential navigation data that indicates the difference between the predicted navigation and the navigation data at the reference date transmitted from the position calculation device. The position calculation device stores the predicted differential navigation data corresponding to the prediction period of the predicted differential navigation data. When the position calculation device does not store navigation data or predicted differential navigation data corresponding to the current date, the position calculation device transmits the current date to the server to request the latest differential navigation data and the predicted differential navigation data corresponding to the prediction period from the current date. The position calculation device stores the latest differential navigation data and the predicted differential navigation data transmitted from the server in response to the request.

Specifically, since the position calculation device acquires the differential data of the latest navigation data and the differential data of the navigation data corresponding to the given prediction period predicted by the server, the position calculation device can calculate its position by performing the positioning calculations within the prediction period without again acquiring the navigation data.

In the position calculation method,

the storing may include storing the reference navigation data corresponding to the reference date of the reference navigation data for each positioning satellite; and

the requesting may include requesting the server to transmit the latest differential navigation data corresponding to each positioning satellite.

According to the above configuration, the reference navigation data is stored corresponding to each positioning satellite, and the server is requested to transmit the latest differential navigation data corresponding to each positioning satellite.

Embodiments of the invention are described below with reference to the drawings. Note that the following embodiments do not in any way limit the scope of the invention laid out in the claims. Note that all elements of the following embodiments should not necessarily be taken as essential requirements for the invention.

Examples of preferred embodiments of the invention are described below with reference to the drawings.

1. System Configuration

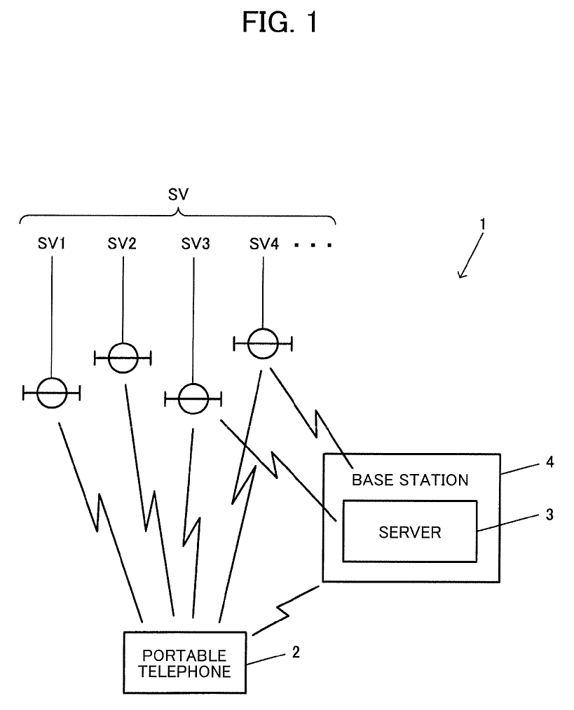

FIG. 1 is a view showing a schematic configuration of a position calculation system 1 according to this embodiment. The position calculation system 1 includes a portable telephone 2 (i.e., electronic instrument including a position calculation device), a portable telephone base station 4, and a plurality of GPS satellites SV (SV1, SV2, SV3, SV4, . . . ). The base station 4 includes a server 3 that provides navigation data to the portable telephone 2.

In FIG. 1, only one base station 4 is illustrated for convenience. A plurality of base stations 4 are provided in the actual situation. Note that each base station need nor include the server 3. In this case, the server 3 is provided as a system independent from the base station, and each base station and the server 3 are connected via communication.

The server 3 is a system provided in the base station 4. The server 3 transmits navigation data including almanac data and ephemeris data to the portable telephone 2 that is located within the communication area of the base station 4 and connected to the base station via wireless communication. In this embodiment, the server 3 has a function of assisting the portable telephone 2 in positioning calculations by providing the ephemeris data of the GPS satellite SV to the portable telephone 2 as position calculation assistance information (i.e., assist GPS).

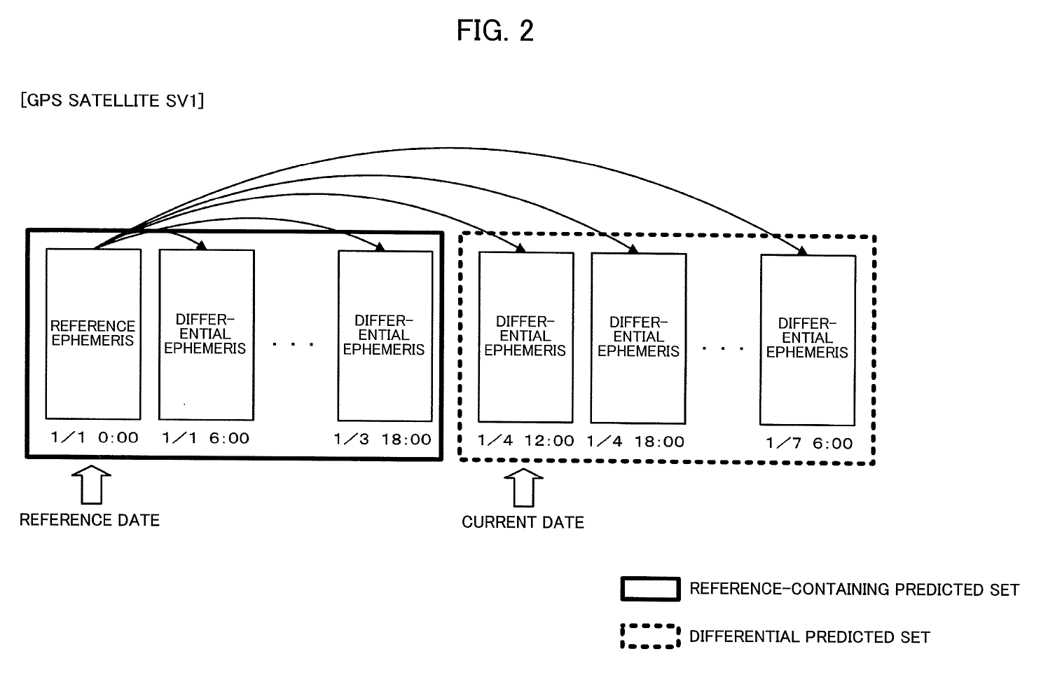

FIG. 2 is a view illustrative of the ephemeris data supply principle according to this embodiment. In the current operation, the ephemeris data is updated every two hours. The effective period of the ephemeris data is considered to be four to six hours. The following description is given on the assumption that the effective period of the ephemeris data is six hours. FIG. 2 shows an example of providing the ephemeris data of one GPS satellite SV1.

The server 3 regularly acquires the latest ephemeris data from the GPS satellite SV or an external system. When the server 3 has acquired the latest ephemeris data, the server 3 performs a known ephemeris prediction process based on the latest ephemeris data to predict ephemeris data corresponding to a given prediction period (e.g., three days) from the current date. The server 3 stores the acquired latest ephemeris data and the predicted ephemeris data.

The term “external system” refers to a navigation data system that provides ephemeris data, such as the National Geodetic Survey (NGS; USA) and the International GPS Service (IGS). Note that another server may acquire the latest ephemeris data from the NGS or the IGS at any time, and the server 3 may acquire the latest ephemeris data from the other server instead of directly acquiring the latest ephemeris data from the NGS or the IGS. In this case, the term “external system” refers to the other server.

The portable telephone 2 stores a reference date and ephemeris data at the reference date (reference ephemeris data) corresponding to each GPS satellite SV. The initial reference ephemeris data may be ephemeris data at an arbitrary date superimposed on a GPS satellite signal received from each GPS satellite SV, or may be ephemeris data at an arbitrary date received from the server 3.

The portable telephone 2 requests the server 3 to transmit ephemeris data corresponding to a given prediction period (e.g., three days) from the current date. When a given time (e.g., 10 days) has not elapsed from the reference date, the portable telephone 2 requests the server 3 to transmit a data set of predicted differential ephemeris data corresponding to the prediction period (hereinafter referred to as “differential predicted set”) instead of requesting the server 3 to transmit complete ephemeris data at each date, the predicted differential ephemeris data being the difference between the reference ephemeris data and complete ephemeris data at each date predicted by the server 3 (hereinafter referred to as “predicted ephemeris data”). The server 3 that has received the request generates the differential predicted set, and transmits the differential predicted set to the portable telephone 2.

The ephemeris data contains 420-bit information for calculating the accurate position of the GPS satellite, such as epoch times “tₒₑ” and “t_{oc}”, semi-major axis “a^{1/2}”, mean anomaly “M₀”, eccentricity “e”, and argument of perigee “ω”. The differential ephemeris data is data that indicates the difference (in each value) between the reference ephemeris data and the ephemeris data at the target date.

In FIG. 2, the reference date of the GPS satellite SV1 is “0:00, Jan. 1”, and the ephemeris data at the reference date is stored as the reference ephemeris data, for example. When the current date is “12:00, Jan. 4”, since the given time “10 days” has not elapsed from the reference date, the portable telephone 2 requests the server 3 to transmit a differential predicted set that includes differential ephemeris data corresponding to three days (“12:00, Jan. 4” to “6:00, Jan. 7”) (12 pieces in total). When the portable telephone 2 has received the differential predicted set from the server 3, the portable telephone 2 stores the differential ephemeris data included in the differential predicted set.

When the given time has elapsed from the reference date, the portable telephone 2 requests the server 3 to transmit a reference-containing predicted set that is a data set of the complete ephemeris data at the current date and differential ephemeris data (i.e., the difference between the complete ephemeris data and predicted ephemeris data) corresponding to the prediction period. The server 3 that has received the request generates the reference-containing predicted set, and transmits the reference-containing predicted set to the portable telephone 2.

When the portable telephone 2 has received the reference-containing predicted set from the server 3, the portable telephone 2 updates the reference ephemeris data currently stored in the portable telephone 2 with the complete ephemeris data at the current date included in the reference-containing predicted set, and updates the reference date corresponding to the reference ephemeris data with the current date.

Specifically, when a long period of time has elapsed from the reference date, the difference between the reference ephemeris data and the predicted ephemeris data may increase. Therefore, the portable telephone 2 requests the server 3 to transmit the latest ephemeris data (complete ephemeris data at the current date), and updates the reference ephemeris data with the latest ephemeris data acquired from the server 3.

2. Portable Telephone

2-1. Functional Configuration

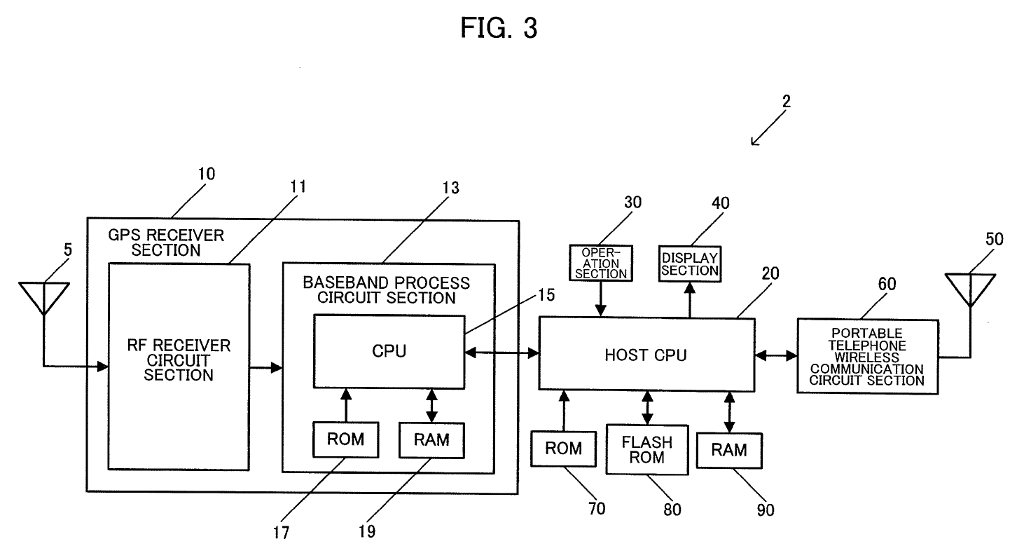

FIG. 3 is a block diagram showing the functional configuration of the portable telephone 2 according to this embodiment. The portable telephone 2 includes a GPS antenna 5, a GPS receiver section 10, a host central processing unit (CPU) 20, an operation section 30, a display section 40, a portable telephone antenna 50, a portable telephone wireless communication circuit section 60, a read-only memory (ROM) 70, a flash ROM 80, and a random access memory (RAM) 90.

The GPS antenna 5 is an antenna that receives a radio frequency (RF) signal including a GPS satellite signal transmitted from a GPS satellite. The GPS antenna 5 outputs the received signal to the GPS receiver section 10. The GPS satellite signal is a 1.57542-GHz communication signal that is directly spread-spectrum-modulated with a pseudo random noise (PRN) code (i.e., a spreading code that differs corresponding to each satellite). The PRN code is a pseudo random noise (PRN) having a code length of 1023 chips (1 PN frame) and a cycle of 1 ms.

The GPS receiver section 10 is a position calculation circuit that locates the current position of the portable telephone 2 based on a signal output from the GPS antenna 5. The GPS receiver section 10 is a functional block corresponding to a GPS receiver. The GPS receiver section 10 includes a radio frequency (RF) receiver circuit section 11 and a baseband process circuit section 13. The RF receiver circuit section 11 and the baseband process circuit section 13 may be produced as different large scale integrated (LSI) circuits, or may be incorporated in one chip.

The RF receiver circuit section 11 is a RF signal processing circuit block. The RF receiver circuit section 11 generates an RF signal multiplication oscillation signal by dividing or multiplying the frequency of a given local oscillation signal. The RF receiver circuit section 11 down-converts the RF signal into an intermediate-frequency signal (hereinafter referred to as “IF signal”) by multiplying the RF signal output from the GPS antenna 5 by the generated oscillation signal, subjecting the IF signal to amplification and the like, converts the resulting signal into a digital signal using an A/D converter, and outputs the digital signal to the baseband process circuit section 13.

The baseband process circuit section 13 is a circuit section that acquires/extracts the GPS satellite signal by performing a correlation process and the like on the IF signal output from the RF receiver circuit section 11, decodes data contained in the GPS satellite signal to extract a navigation message, time information, and the like, and performs positioning calculations. The baseband process circuit section 13 includes a CPU 15 (processor), a ROM 17 (memory), and a RAM 19 (memory).

In this embodiment, the CPU 15 calculates the position of the portable telephone 2 by performing given positioning calculations using ephemeris data expanded by the host CPU 20 based on the differential predicted set or the reference-containing predicted set received from the server 3. The positioning calculations may be performed using a known method such as positioning calculations using a least-square method or a Kalman filter.

The host CPU 20 is a processor that controls each section of the portable telephone 2 based on various programs such as a system program stored in the ROM 70. The host CPU 20 expands the ephemeris data based on the differential predicted set or the reference-containing predicted set received from the server 3 according to a first position calculation program 701, and causes the CPU 15 to perform given positioning calculations to calculate the position of the portable telephone 2. The host CPU 20 causes the display section 40 to display the position calculated by the positioning calculations.

The operation section 30 is an input device including a touch panel, a button switch, and the like, and outputs a signal that indicates a pressed icon or button to the host CPU 20. The user inputs various instructions such as a telephone call request, an e-mail send/receive request, or a GPS start request by operating the operation section 30.

The display section 40 is a display device that includes a liquid crystal display (LCD) or the like, and displays various images based on a display signal input from the host CPU 20. The display section 40 displays a navigation screen, time information, and the like.

The portable telephone antenna 50 is an antenna that transmits and receives a portable telephone radio signal and various types of data between the portable telephone 2 and the server 3 provided in the base station 4 installed by a communication service provider of the portable telephone 2.

The portable telephone wireless communication circuit section 60 is a portable telephone communication circuit section that includes an RF conversion circuit, a baseband process circuit, and the like. The portable telephone wireless communication circuit section 60 implements a telephone call, an e-mail send/receive process, or the like by modulating/demodulating the portable telephone radio signal, for example.

The ROM 70 is a read-only nonvolatile storage device. The ROM 70 stores a system program that causes the host CPU 20 to control the portable telephone 2, a program and data that implement a navigation function, and the like.

The flash ROM 80 is a rewritable nonvolatile storage device. The flash ROM 80 stores a program data, and the like that cause the host CPU 20 to control the portable telephone 2. The data stored in the flash ROM 80 is not lost even if the portable telephone 2 is disconnected from the power supply.

The RAM 90 is a rewritable volatile storage device. The RAM 90 serves as a work area that temporarily stores a system program executed by the host CPU 20, a processing program, processed data, processing results, and the like.

2-2. Data Configuration

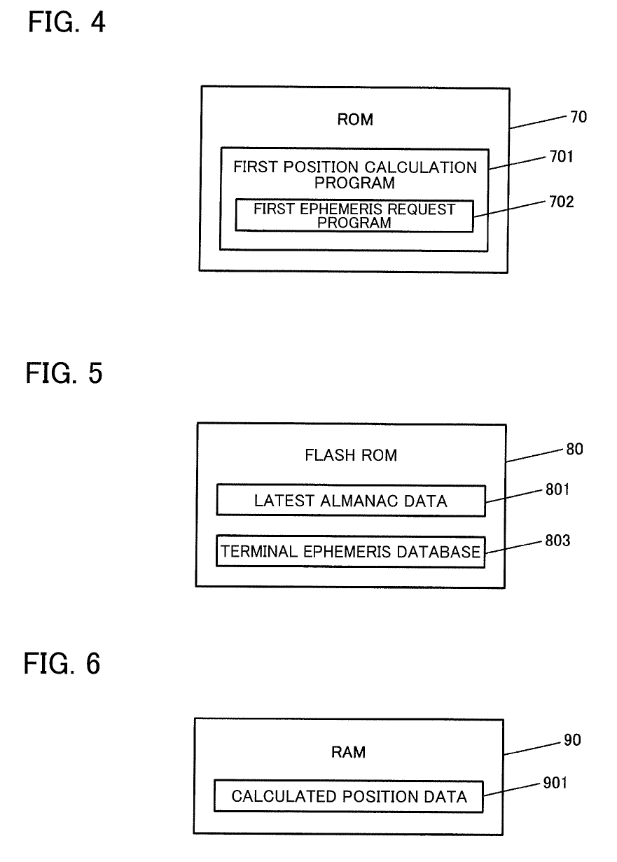

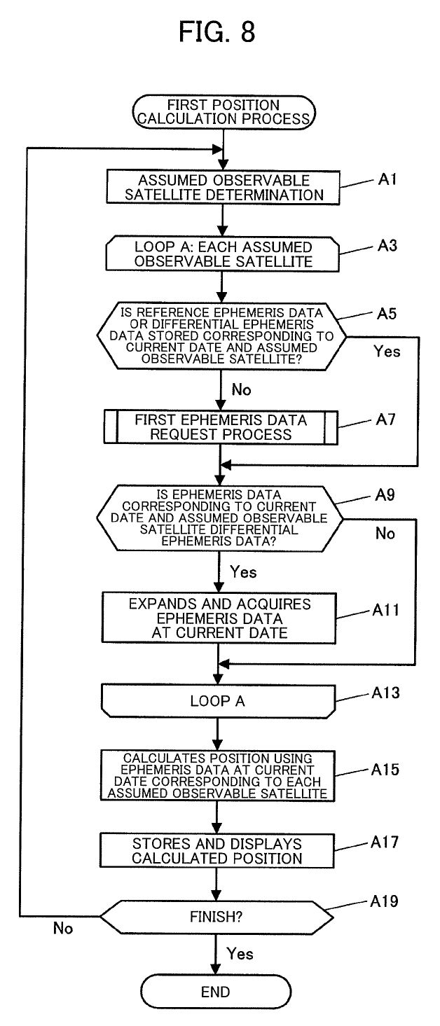

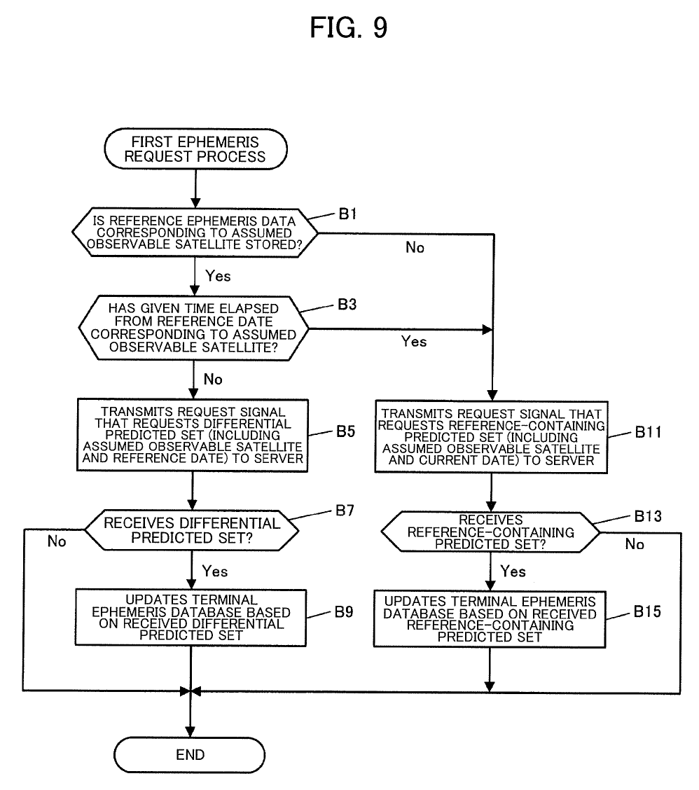

FIG. 4 is a view showing an example of data stored in the ROM 70. The ROM 70 stores the first position calculation program 701 that is read by the host CPU 20 and executed as a first position calculation process (see FIG. 8). The first position calculation program 701 includes a first ephemeris request program 702 that is executed as a first ephemeris request process (see FIG. 9) as a subroutine.

The first position calculation process is a process that causes the host CPU 20 to expand the ephemeris data at the current date based on the ephemeris data predicted set acquired from the server 3 corresponding to each satellite that is considered to be directly observable from the current position (hereinafter referred to as “assumed observable satellite”), and calculate the position of the portable telephone 2 using the ephemeris data. The details of the first position calculation process are described later using a flowchart.

The first ephemeris request process is a process that causes the host CPU 20 to request the server 3 to transmit a differential predicted set when the reference ephemeris data of each assumed observable satellite has been stored in the portable telephone 2 and a given period (e.g., 10 days) has not elapsed from the reference date of each assumed observable satellite, and otherwise request the server 3 to transmit a reference-containing predicted set. The details of the first ephemeris request process are described later using a flowchart.

FIG. 5 is a view showing an example of data stored in the flash ROM 80. The flash ROM 80 stores latest almanac data 801 and a terminal ephemeris database 803.

The latest almanac data (i.e., approximate orbit information) of each GPS satellite SV is stored as the latest almanac data 801. The latest almanac data 801 may be extracted/acquired from the GPS satellite signal received from the GPS satellite SV, or may be acquired from the server 3. The host CPU 20 uses the latest almanac data 801 in the first position calculation process in order to determine the assumed observable satellite.

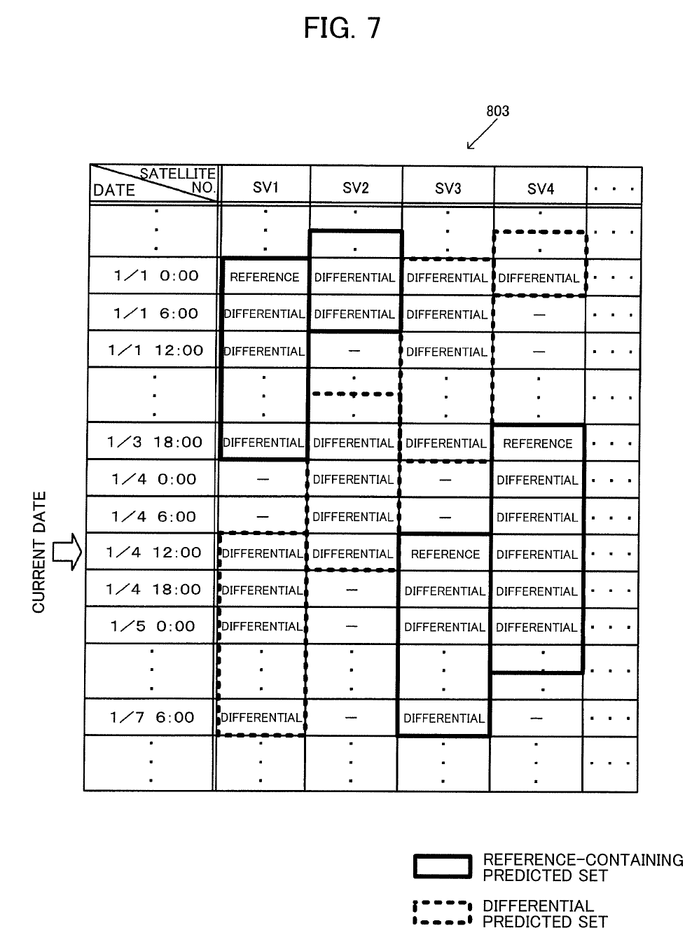

FIG. 7 is a view showing an example of the data configuration of the terminal ephemeris database 803. The terminal ephemeris database 803 stores the date (every six hours) and the reference ephemeris data or the differential ephemeris data corresponding to each date for each GPS satellite SV (SV1, SV2, SV3, SV4, . . . ). The time interval of six hours is employed since the description is given on the assumption that the effective period of the ephemeris data is six hours. The time interval may be appropriately changed corresponding to the actual effective period and the date.

In FIG. 7, “Reference” and “Differential” respectively indicate that the reference ephemeris data and the differential ephemeris data are stored corresponding to the satellite and the date. “-” indicates that no data is stored. In FIG. 7, areas corresponding to the reference-containing predicted set and the differential predicted set are enclosed by a bold solid line and a bold dotted line, respectively.

Suppose that the current date is “12:00, Jan. 4”, for example. In this case, since the given time “10 days” has elapsed from the reference date for the GPS satellite SV3, the portable telephone 2 requests the server 3 to transmit a reference-containing predicted set. Therefore, the portable telephone 2 acquires and stores the reference-containing predicted set that includes ephemeris data corresponding to three days (“12:00, Jan. 4” to “6:00, Jan. 7”) (12 pieces in total) (see FIG. 7).

Regarding the GPS satellite SV4, the reference-containing predicted set was acquired on “18:00, Jan. 3”. Specifically, the differential ephemeris data has been stored as data corresponding to the current date. In this case, since the complete ephemeris data at the current date can be expanded and acquired based on the reference ephemeris data at the reference date (18:00, Jan. 3) and the differential ephemeris data at the current date (12:00, Jan. 4) without acquiring the predicted set from the server 3, the portable telephone 2 does not request the server 3 to transmit the predicted set. The terminal ephemeris database 803 is updated by the host CPU 20 in the first position calculation process.

FIG. 6 is a view showing an example of data stored in the RAM 90. The RAM 90 stores calculated position data 901 that indicates the position calculated by the positioning calculations in the position calculation process. The calculated position data 901 is updated by the host CPU 20 in the first position calculation process.

2-3. Process Flow

FIG. 8 shows the flow of the first position calculation process that is performed in the portable telephone 2 by causing the host CPU 20 to read and execute the first position calculation program 701 stored in the ROM 70.

The first position calculation process starts when the host CPU 20 has detected that the RF receiver circuit section 11 has received the GPS satellite signal and the user has performed a positioning start instruction using the operation section 30. The first position calculation process is performed in parallel with various processes (e.g., execution of various application programs). An operation that causes the portable telephone 2 to be turned ON/OFF may be associated with GPS startup/suspension, and the first position calculation process may be performed when an operation that causes the portable telephone 2 to be turned ON has been detected.

The host CPU 20 determines assumed observable satellites referring to the latest almanac data stored in the flash ROM 80 as the latest almanac data 801 (step A1). The host CPU 20 executes a loop A process corresponding to each assumed observable satellite (steps A3 to A13).

In the loop A, the host CPU 20 determines whether or not the reference ephemeris data or the differential ephemeris data is stored in the terminal ephemeris database 803 stored in the flash ROM 80 corresponding to the current date and the assumed observable satellite (step A5). When the host CPU 20 has determined that the reference ephemeris data or the differential ephemeris data is stored in the terminal ephemeris database 803 (step A5: Yes), the host CPU 20 transitions to a step A9. When the host CPU 20 has determined that the reference ephemeris data or the differential ephemeris data is not stored in the terminal ephemeris database 803 (step A5: No), the host CPU 20 performs the first ephemeris request process by reading and executing the first ephemeris request program 702 stored in the ROM 70 (step A7).

FIG. 9 is a flowchart showing the flow of the first ephemeris request process.

The host CPU 20 determines whether or not the reference ephemeris data corresponding to the assumed observable satellite is stored in the terminal ephemeris database 803 (step B1). When the host CPU 20 has determined that the reference ephemeris data corresponding to the assumed observable satellite is stored in the terminal ephemeris database 803 (step B1: Yes), the host CPU 20 determines whether or not the given time (e.g., 10 days) has elapsed from the reference date corresponding to the assumed observable satellite (step B3).

When the host CPU 20 has determined that the given time has not elapsed from the reference date in the step B3 (step B3: No), the host CPU 20 transmits a request signal that requests the server 3 to transmit a differential predicted set (including the assumed observable satellite and the reference date) to the server 3 through the portable telephone antenna 50 and the portable telephone wireless communication circuit section 60 (step B5).

The host CPU 20 determines whether or not the differential predicted set has been received from the server 3 (step B7). When the host CPU 20 has determined that the differential predicted set has not been received from the server 3 (step B7: No), the host CPU 20 finishes the first ephemeris request process. When the host CPU 20 has determined that the differential predicted set has been received from the server 3 (step B7: Yes), the host CPU 20 updates the terminal ephemeris database 803 based on the received differential predicted set (step B9). The host CPU 20 then finishes the first ephemeris request process.

When the host CPU 20 has determined that the reference ephemeris data corresponding to the assumed observable satellite is not stored in the step B1 (step B1: No), or has determined that the given time has elapsed from the reference date in the step B3 (step B3: Yes), the host CPU 20 transmits a request signal that requests the server 3 to transmit a reference-containing predicted set (including the assumed observable satellite and the current date) to the server 3 through the portable telephone antenna 50 and the portable telephone wireless communication circuit section 60 (step B11).

The host CPU 20 determines whether or not the reference-containing predicted set has been received from the server 3 (step B13). When the host CPU 20 has determined that the reference-containing predicted set has not been received from the server 3 (step B13: No), the host CPU 20 finishes the first ephemeris request process. When the host CPU 20 has determined that the reference-containing predicted set has been received from the server 3 (step B13: Yes), the host CPU 20 updates the terminal ephemeris database 803 based on the received reference-containing predicted set (step B15). The host CPU 20 then finishes the first ephemeris request process.

Again referring to the first position calculation process shown in FIG. 8, the host CPU 20 determines whether or not the ephemeris data at the current date corresponding to the assumed observable satellite is differential ephemeris data (step A9). When the host CPU 20 has determined that the ephemeris data is not differential ephemeris data but is reference ephemeris data (step A9: No), the host CPU 20 performs the process on the next assumed observable satellite.

When the host CPU 20 has determined that the ephemeris data is differential ephemeris data in the step A9 (step A9: Yes), the host CPU 20 expands and acquires the ephemeris data at the current date based on the reference ephemeris data corresponding to the assumed observable satellite and the differential ephemeris data at the current date stored in the terminal ephemeris database 803 (step A11). The host CPU 20 then performs the process on the next assumed observable satellite.

When the host CPU 20 has performed the loop A process on each assumed observable satellite, the host CPU 20 calculates the position of the portable telephone 2 using the ephemeris data at the current date corresponding to each assumed observable satellite (step A15). Specifically, the host CPU 20 causes the CPU 15 of the baseband process circuit section 13 to perform positioning calculations using a least-square method or a Kalman filter based on the ephemeris data at the current date corresponding to each assumed observable satellite.

The host CPU 20 stores the calculated position in the RAM 90 as the calculated position data 901, and causes the display section 40 to display the calculated position (step A17). The host CPU 20 then determines whether or not to finish the process (step A19). When the host CPU 30 has determined to continue the process (step A19: No), the host CPU 20 returns to the step A1. When the host CPU 20 has determined to finish the process (step A19: Yes), the host CPU 20 finishes the first position calculation process.

3. Server

3-1. Functional Configuration

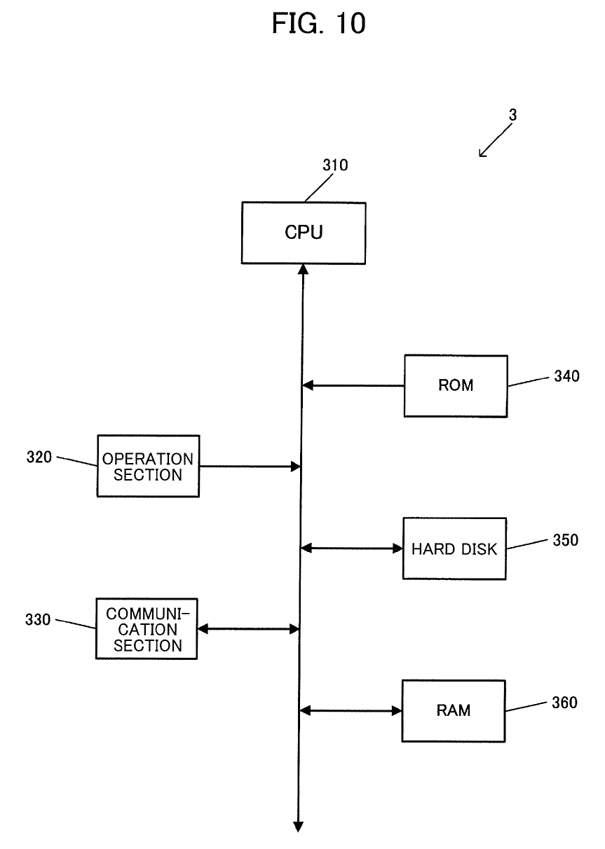

FIG. 10 is a block diagram showing the functional configuration of the server 3. The server 3 includes a CPU 310, an operation section 320, a communication section 330, a ROM 340, a hard disk 350, and a RAM 360.

The CPU 310 is a processor that controls each section of the server 3 based on a system program stored in the ROM 340, for example. In this embodiment, the CPU 310 performs a first ephemeris supply process according to a first ephemeris supply program 341 stored in the ROM 340.

The operation section 320 is an input device that receives operation instructions from the administrator of the server 3 and outputs a signal corresponding to the operation to the CPU 310. The function of the operation section 320 is implemented by a keyboard, a button, a mouse, and the like.

The communication section 330 is a communication device that includes a communication circuit that exchanges a portable telephone radio signal and various types of data with the portable telephone 2.

The ROM 340 stores a system program that causes the CPU 310 to control the server 3, a program for supplying the ephemeris data to the portable telephone 2, data, and the like.

The hard disk 350 is a storage device that allows data to be read and written using a magnetic head or the like. The hard disk 350 stores a program that implements various functions of the server 3, data, and the like.

The RAM 360 is used as a work area for the CPU 310, and mainly stores data processed in the first ephemeris supply process.

3-2. Data Configuration

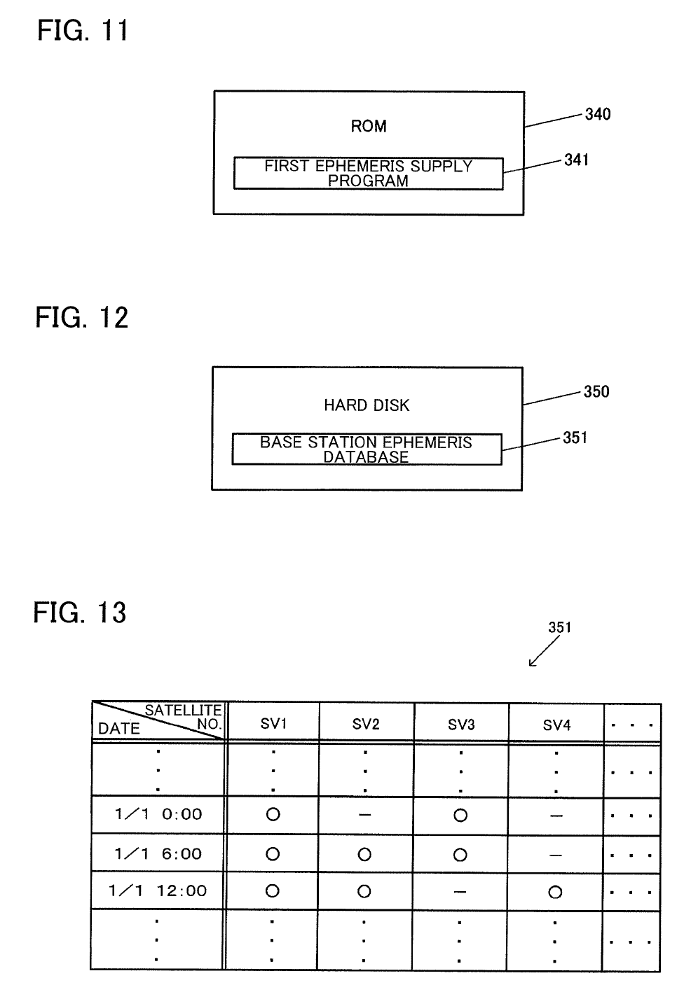

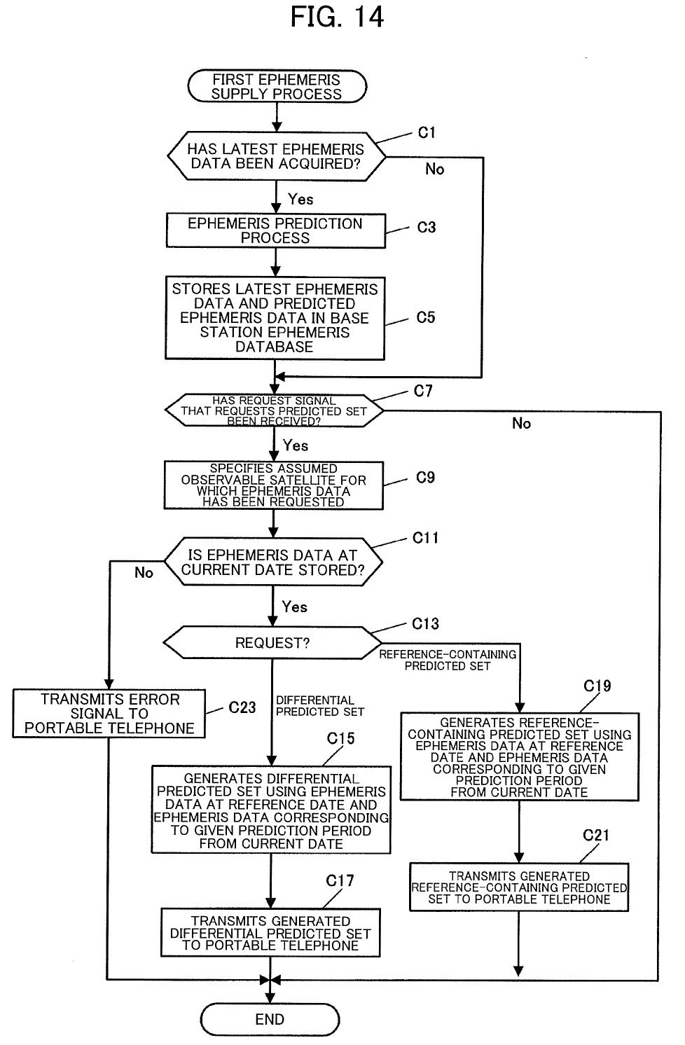

FIG. 11 is a view showing an example of data stored in the ROM 340. The ROM 340 stores a first ephemeris supply program 341 that is read by the CPU 310 and executed as the first ephemeris supply process (see FIG. 14).

The first ephemeris supply process is a process that causes the CPU 310 to perform a known ephemeris prediction process when ephemeris data has been acquired from a GPS satellite or an external system, and predict ephemeris data corresponding to a given prediction period (e.g., three days) from the current date. When the server 3 has received a request signal that requests an ephemeris data predicted set from the portable telephone 2, the CPU 310 generates a differential predicted set or a reference-containing predicted set according to the request, and transmits the differential predicted set or reference-containing predicted set to the portable telephone 2. The details of the first ephemeris supply process are described later using a flowchart.

FIG. 12 is a view showing an example of data stored in the hard disk 350. A base station ephemeris database 351 is stored in the hard disk 350.

FIG. 13 is a view showing an example of the data configuration of the base station ephemeris database 351. The base station ephemeris database 351 stores the date (every six hours) and the ephemeris data corresponding to each date corresponding to each GPS satellite SV (SV1, SV2, SV3, SV4, . . . ). The time interval of six hours is employed since the description is given on the assumption that the effective period of the ephemeris data is six hours. The time interval may be appropriately changed corresponding to the actual effective period and the date.

The CPU 310 stores the latest ephemeris data acquired from a GPS satellite or an external system and ephemeris data corresponding to a given prediction period predicted based on the latest ephemeris data in the base station ephemeris database 351.

In FIG. 13, a circle indicates that the ephemeris data is stored, and “-” indicates that the ephemeris data is not stored. For example, ephemeris data corresponding to “0:00, Jan. 1” and “6:00, Jan. 1” is stored corresponding to the GPS satellite SV3, and ephemeris data corresponding to “12:00, Jan. 1” is not stored corresponding to the GPS satellite SV3.

3-3. Process Flow

FIG. 14 is a flowchart showing the flow of the first ephemeris supply process performed in the server 3 by causing the CPU 310 to read and execute the first ephemeris supply program 341 stored in the ROM 340.

The CPU 310 determines whether or not the latest ephemeris data has been acquired from a GPS satellite or an external system (step C1). When the CPU 310 has determined that the latest ephemeris data has not been acquired from a GPS satellite or an external system (step C1: No), the CPU 310 transitions to a step C7. When the CPU 310 has determined that the latest ephemeris data has been acquired from a GPS satellite or an external system (step C1: Yes), the CPU 310 performs the ephemeris prediction process (step C3).

Specifically, the CPU 310 performs given prediction calculations based on detailed orbit information relating to the GPS satellite included in the latest ephemeris data acquired in the step C1 to predict ephemeris data corresponding to the given prediction period (e.g., three days) from the current date. The prediction calculations may be performed using a known method. Therefore, detailed description of the prediction calculations is omitted.

The CPU 310 stores the latest ephemeris data acquired in the step C1 and the ephemeris data corresponding to the given prediction period predicted in the step C3 in the base station ephemeris database 351 stored in the hard disk 350 (step C5).

The CPU 310 then determines whether or not a request signal that requests an ephemeris data predicted set has been received from the portable telephone 2 (step C7). When the CPU 310 has determined that a request signal that requests an ephemeris data predicted set has not been received from the portable telephone 2 (step C7: No), the CPU 310 finishes the first ephemeris supply process. When the CPU 310 has determined that a request signal that requests an ephemeris data predicted set has been received from the portable telephone 2 (step C7: Yes), the CPU 310 specifies an assumed observable satellite for which the ephemeris data has been requested using the request signal (step C9).

The CPU 310 then determines whether or not ephemeris data at the current date is stored corresponding to the assumed observable satellite specified in the step C9 referring to the base station ephemeris database 351 (step C11). When the CPU 310 has determined that ephemeris data at the current date is stored corresponding to the assumed observable satellite specified in the step C9 (step C11: Yes), the CPU 310 checks the request from the portable telephone 2 (step C13).

When the CPU 310 has determined that the portable telephone 2 has requested a differential predicted set (step C13: differential predicted set), the CPU 310 generates a differential predicted set using the ephemeris data at the reference date and the ephemeris data corresponding to the given prediction period from the current date stored in the base station ephemeris database 351 (step C15). The CPU 310 transmits the generated differential predicted set to the portable telephone 2 through the communication section 330 (step C17), and finishes the first ephemeris supply process.

When the CPU 310 has determined that the portable telephone 2 has requested a reference-containing predicted set (step C13: reference-containing predicted set), the CPU 310 generates a reference-containing predicted set using the ephemeris data at the reference date and the ephemeris data corresponding to the given prediction period from the current date stored in the base station ephemeris database 351 (step C19). The CPU 310 transmits the generated reference-containing predicted set to the portable telephone 2 through the communication section 330 (step C21), and finishes the first ephemeris supply process.

When the CPU 310 has determined that ephemeris data at the current date is not stored in the step C11 (step C11: No), the CPU 310 transmits an error signal to the portable telephone 2 through the communication section 330 (step C23). The CPU 310 then finishes the first ephemeris supply process.

4. Effects

In the position calculation system 1, the portable telephone 2 requests the server 3 to transmit differential ephemeris data that is the difference between the ephemeris data at the given reference date and the ephemeris data at the current date. The server 3 that has received the request generates differential ephemeris data at the current date using ephemeris data that has been acquired from a GPS satellite or an external system and stored, based on the ephemeris data at the reference date transmitted from the portable telephone 2 and the ephemeris data at the current date, and transmits the differential ephemeris data to the portable telephone 2. The portable telephone 2 performs given positioning calculations based on the differential ephemeris data at the current date received from the server 3 and the reference ephemeris data stored in the portable telephone 2 to calculate the position of the portable telephone 2.

Since the differential ephemeris data at the current date is indicated by the difference between the ephemeris data at the reference date and the ephemeris data at the current date, the amount of the differential ephemeris data is smaller than that of the ephemeris data at the current date. Moreover, since the portable telephone 2 can receive the data from server 3 by a data transmission-specific communication method, differing from a position calculation signal method (e.g., GPS satellite signal), the period of time required to transmit and receive the differential ephemeris data at the current date is significantly reduced as compared with the period of time required to acquire the complete ephemeris data at the current date through a GPS satellite signal from a GPS satellite. Since the portable telephone 2 acquires the ephemeris data from the server 3, the portable telephone 2 can reliably acquire the navigation data without being affected by the environment.

The server 3 predicts the ephemeris data corresponding to the given prediction period, and calculates the predicted differential ephemeris data that is the difference between the predicted ephemeris data and the ephemeris data at the reference date transmitted from the portable telephone 2. The portable telephone 2 stores the predicted differential ephemeris data corresponding to the prediction period of the predicted differential ephemeris data. When the portable telephone 2 does not store ephemeris data or predicted differential ephemeris data corresponding to the current date, the portable telephone 2 transmits the current date to the server 3 to request the differential ephemeris data at the current date and the predicted differential ephemeris data corresponding to the prediction period from the current date. The portable telephone 2 stores the differential ephemeris data at the current date and the predicted differential navigation data transmitted from the server 3 in response to the request.

Specifically, since the portable telephone 2 acquires the differential data of the latest ephemeris data and the differential data of the ephemeris data corresponding to the given prediction period predicted by the server 3, the portable telephone 2 can calculate its position by performing the given positioning calculations within the prediction period without again acquiring the ephemeris data.

5. Modification

5-1. Position Calculation System

The above embodiments have been described taking the position calculation system 1 that includes the portable telephone 2 and the server 3 as an example. Note that the position calculation system to which the invention may be applied is not limited thereto. For example, the invention may be applied to an electronic instrument that includes a position calculation device, such as a notebook personal computer, a personal digital assistant (PDA), or a car navigation system instead of the portable telephone 2.

The above embodiments have been described taking an example in which each base station 4 includes the server 3. Note that the server 3 may be provided independently insofar as the server 3 can acquire the navigation data by communicating with the National Geodetic Survey (NGS) or the International GPS Service (IGS), or can directly receive and acquire the navigation data from a GPS satellite, and can communicate with the portable telephone 2.

5-2. Satellite Positioning System

The above embodiments have been described taking the GPS as an example of the satellite positioning system. Note that the invention may also be applied to other satellite positioning systems such as the wide area augmentation system (WAAS), the quasi zenith satellite system (QZSS), the global navigation satellite system (GLONASS), and the GALILEO.

5-3. Process Split

The CPU 15 may perform some or all of the processes performed by the host CPU 20. For example, the CPU 15 performs the first ephemeris request process to request the server 3 to transmit an ephemeris data predicted set, expands the ephemeris data based on the acquired predicted set, and performs positioning calculations. The host CPU 20 may perform the positioning calculations instead of the CPU 15.

5-4. Ephemeris Prediction Process

The above embodiments have been described taking an example in which the server 3 performs the ephemeris prediction process to predict the ephemeris data corresponding to the given prediction period from the current date. Note that the portable telephone 2 may perform the ephemeris prediction process.

In this case, a second position calculation program is stored in the ROM 70 of the portable telephone 2 instead of the first position calculation program 701, and a second ephemeris request program is stored as a subroutine of the second position calculation program. The host CPU 20 performs a second position calculation process and a second ephemeris request process according to these programs.

A second ephemeris supply program is stored in the ROM 340 of the server 3 instead of the first ephemeris supply program 341, and the CPU 310 performs a second ephemeris supply process according to the second ephemeris supply program. The details of these processes are described below using a flowchart.

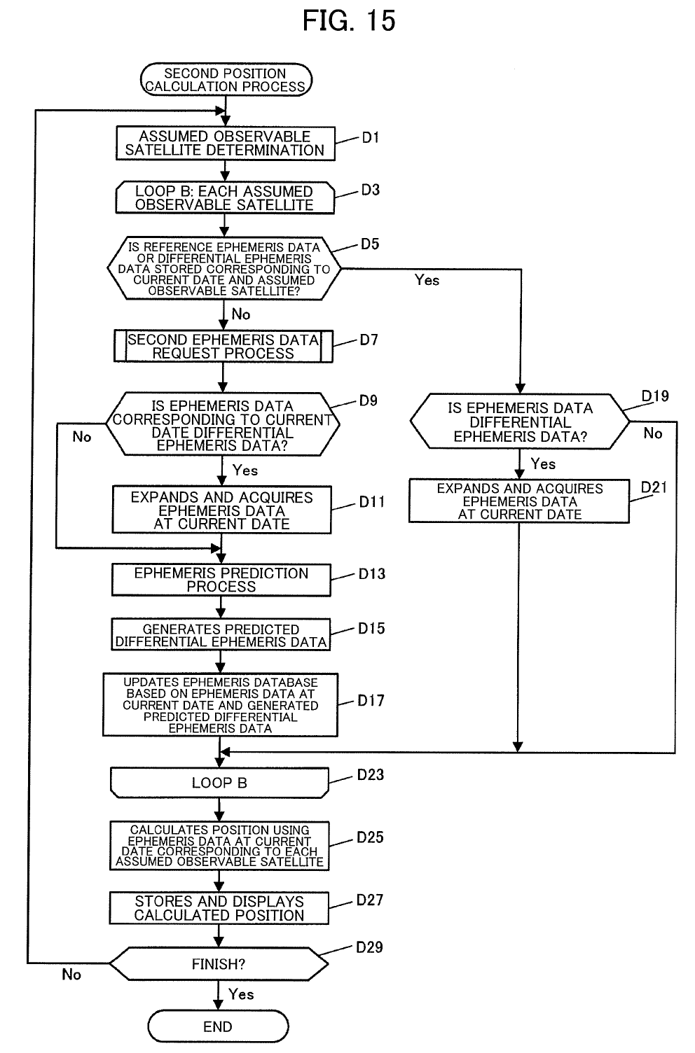

FIG. 15 is a flowchart showing the flow of the second position calculation process.

The host CPU 20 determines assumed observable satellites referring to the latest almanac data stored in the flash ROM 80 as the latest almanac data 801 (step D1). The host CPU 20 executes a loop B process corresponding to each assumed observable satellite (steps D3 to D23).

In the loop B, the host CPU 20 determines whether or not the reference ephemeris data or the differential ephemeris data is stored in the terminal ephemeris database 803 stored in the flash ROM 80 corresponding to the current date and the assumed observable satellite (step D5). When the host CPU 20 has determined that the reference ephemeris data or the differential ephemeris data is not stored (step D5: No), the host CPU 20 performs the second ephemeris request process by reading and executing the second ephemeris request program stored in the ROM 70 (step D7).

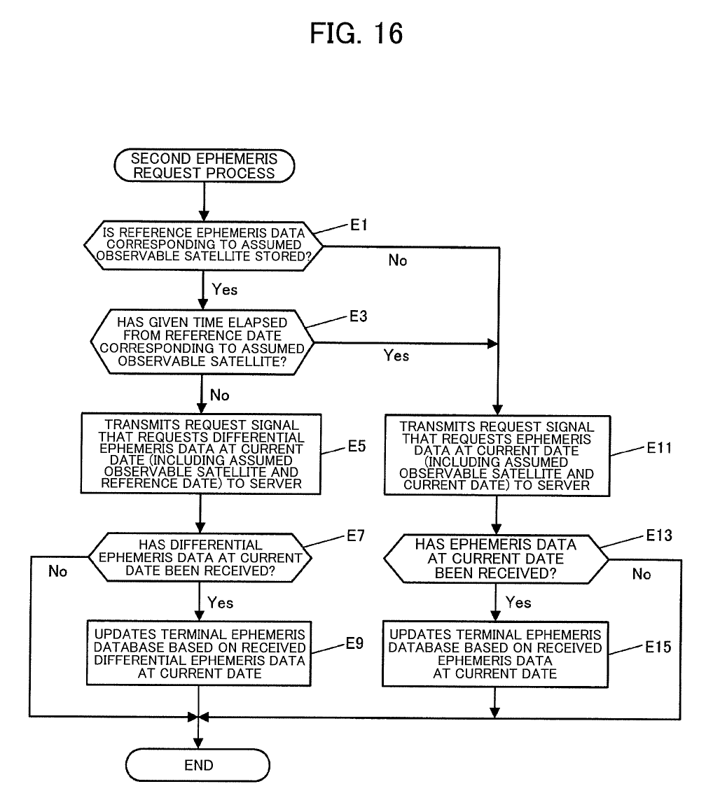

FIG. 16 is a flowchart showing the flow of the second ephemeris request process.

The host CPU 20 determines whether or not ephemeris data corresponding to the assumed observable satellite is stored in the terminal ephemeris database 803 stored in the flash ROM 80 (step E1). When the host CPU 20 has determined that ephemeris data corresponding to the assumed observable satellite is stored in the terminal ephemeris database 803 (step E1: Yes), the host CPU 20 determines whether or not the given time has elapsed from the reference date of the assumed observable satellite (step E3).

When the host CPU 20 has determined that the given time has not elapsed from the reference date of the assumed observable satellite (step E3: No), the host CPU 20 transmits a request signal that requests the server 3 to transmit a differential ephemeris data at the current date (including the assumed observable satellite and the reference date) to the server 3 through the portable telephone antenna 50 and the portable telephone wireless communication circuit section 60 (step E5).

The host CPU 20 determines whether or not the differential ephemeris data at the current date has been received from the server 3 (step E7). When the host CPU 20 has determined that the differential ephemeris data at the current date has not been received from the server 3 (step E7: No), the host CPU 20 finishes the second ephemeris request process. When the host CPU 20 has determined that the differential ephemeris data at the current date has been received from the server 3 (step E7: Yes), the host CPU 20 updates the terminal ephemeris database 803 based on the received differential ephemeris data at the current date (step E9), and finishes the second ephemeris request process.

When the host CPU 20 has determined that the reference ephemeris data corresponding to the assumed observable satellite is not stored in the step E1 (step E1: No), or has determined that the given time has elapsed from the reference date of the assumed observable satellite in the step E3 (step E3: Yes), the host CPU 20 transmits a request signal that requests the server 3 to transmit the ephemeris data at the current date including the assumed observable satellite and the current date to the server 3 through the portable telephone antenna 50 and the portable telephone wireless communication circuit section 60 (step E11).

The host CPU 20 determines whether or not the ephemeris data at the current date has been received from the server 3 (step E13). When the host CPU 20 has determined that the ephemeris data at the current date has not been received from the server 3 (step E13: No), the host CPU 20 finishes the second ephemeris request process. When the host CPU 20 has determined that the ephemeris data at the current date has been received from the server 3 (step E13: Yes), the host CPU 20 updates the terminal ephemeris database 803 based on the received ephemeris data at the current date (step E15), and finishes the second ephemeris request process.

Again referring to the second position calculation process shown in FIG. 15, the host CPU 20 then determines whether or not the acquired ephemeris data at the current date is differential ephemeris data (step D9). When the host CPU 20 has determined that the ephemeris data is not differential ephemeris data but is complete ephemeris data (step D9: No), the host CPU 20 transitions to a step D13.

When the host CPU 20 has determined that the ephemeris data is differential ephemeris data (step D9: Yes), the host CPU 20 expands and acquires the ephemeris data at the current date based on the reference ephemeris data and the differential ephemeris data referring to the terminal ephemeris database 803 (step D11). The host CPU 20 then performs the ephemeris prediction process that predicts the ephemeris data corresponding to the given prediction period from the current date based on the ephemeris data at the current date by performing known prediction calculations (step D13).

The host CPU 20 then generates predicted differential ephemeris data corresponding to the prediction period based on the ephemeris data predicted in the step D13 and the reference ephemeris data (step D15). The host CPU 20 updates the terminal ephemeris database 803 based on the ephemeris data at the current date and the predicted differential ephemeris data corresponding to the prediction period generated in the step D15 (step D17), and performs the process on the next assumed observable satellite.

When the host CPU 20 has determined that the reference ephemeris data or the differential ephemeris data at the current date corresponding to the assumed observable satellite is stored in the step D5 (step D5: Yes), the host CPU 20 determines whether or not the ephemeris data is differential ephemeris data (step D19). When the host CPU 20 has determined that the ephemeris data is not differential ephemeris data (step D19: No), the host CPU 20 performs the process on the next assumed observable satellite.

When the host CPU 20 has determined that the ephemeris data is differential ephemeris data (step D19: Yes), the host CPU 20 expands and acquires the ephemeris data at the current date based on the reference ephemeris data and the differential ephemeris data referring to the terminal ephemeris database 803 (step D21). The host CPU 20 then performs the process on the next assumed observable satellite.

After the host CPU 20 has performed the process in the steps D5 to D21 on all of the assumed observable satellites, the host CPU 20 finishes the loop B. The host CPU 20 then calculates the position of the portable telephone 2 using the ephemeris data at the current date corresponding to each assumed observable satellite (step D25). The host CPU 20 stores and displays the position calculated by the positioning calculations (step D27), and determines whether or not to finish the process (step D29).

When the host CPU 20 has determined to continue the process in the step D29 (step D29: No), the host CPU 20 returns to the step D1. When the host CPU 20 has determined to finish the process (step D29: Yes), the host CPU 20 finishes the second position calculation process.

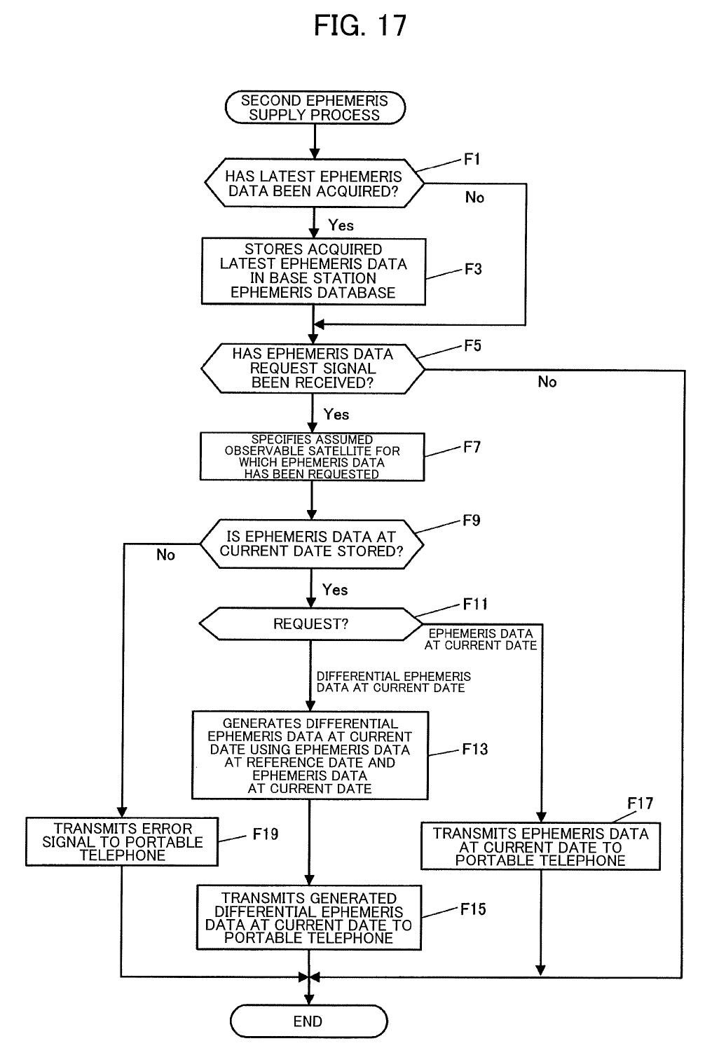

FIG. 17 is a flowchart showing the flow of the second ephemeris supply process.

The CPU 310 determines whether or not the latest ephemeris data has been acquired from a GPS satellite or an external system (step F1). When the CPU 310 has determined that the latest ephemeris data has not been acquired from a GPS satellite or an external system (step F1: No), the CPU 310 transitions to a step F5. When the CPU 310 has determined that the latest ephemeris data has been acquired from a GPS satellite or an external system (step F1: Yes), the CPU 310 stores the acquired latest ephemeris data in the base station ephemeris database 351 stored in the hard disk 350 (step F3).

The CPU 310 then determines whether or not an ephemeris data request signal has been received from the portable telephone 2 (step F5). When the CPU 310 has determined that an ephemeris data request signal has not been received from the portable telephone 2 (step F5: No), the CPU 310 finishes the second ephemeris supply process. When the CPU 310 has determined that an ephemeris data request signal has been received from the portable telephone 2 (step F5: Yes), the CPU 310 specifies an assumed observable satellite for which the ephemeris data has been requested using the request signal (step F7).

The CPU 310 then determines whether or not ephemeris data at the current date is stored corresponding to the assumed observable satellite specified in the step F7 referring to the base station ephemeris database 351 (step F9). When the CPU 310 has determined that ephemeris data at the current date is stored corresponding to the assumed observable satellite specified (step F9: Yes), the CPU 310 checks the request from the portable telephone 2 (step F11).

When the CPU 310 has determined that the portable telephone 2 has requested differential ephemeris data at the current date (step F11: differential ephemeris data at current date), the CPU 310 generates differential ephemeris data at the current date using the ephemeris data at the reference date and the ephemeris data at the current date stored in the base station ephemeris database 351 (step F13). The CPU 310 transmits the generated differential ephemeris data at the current date to the portable telephone 2 (step F15).

When the CPU 310 has determined that the portable telephone 2 has requested ephemeris data at the current date (step F11: ephemeris data at current date), the CPU 310 transmits the ephemeris data at the current date stored in the base station ephemeris database 351 to the portable telephone 2 (step F17). The CPU 310 then finishes the second ephemeris supply process.

When the CPU 310 has determined that ephemeris data at the current date is not stored in the step F9 (step F9: No), the CPU 310 transmits an error signal to the portable telephone 2 through the communication section 330 (step F19). The CPU 310 then finishes the second ephemeris supply process.

5-5. Update of Reference Ephemeris Data

When the portable telephone 2 has stored the reference ephemeris data and the differential ephemeris data at the current date, complete ephemeris data at the current date may be generated using the reference ephemeris data and the differential ephemeris data at the current date, and the reference ephemeris data may be updated with the generated ephemeris data. In this case, a third ephemeris request program is stored in the ROM 70 of the portable telephone 2, and the host CPU 20 performs a third ephemeris request process according to the third ephemeris request program.

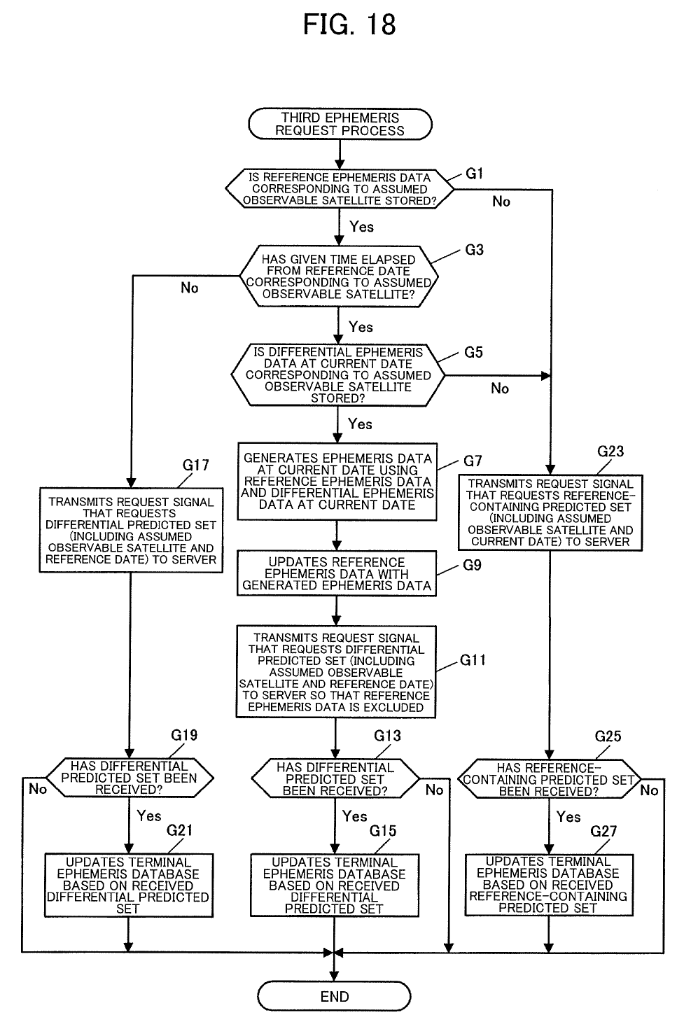

FIG. 18 is a flowchart showing the flow of the third ephemeris request process.

The host CPU 20 determines whether or not ephemeris data corresponding to the assumed observable satellite is stored in the terminal ephemeris database 803 stored in the flash ROM 80 (step G1). When the host CPU 20 has determined that ephemeris data corresponding to the assumed observable satellite is stored in the terminal ephemeris database 803 (step G1: Yes), the host CPU 20 determines whether or not the given time has elapsed from the reference date of the assumed observable satellite (step G3).

When the host CPU 20 has determined that the given time has elapsed from the reference date of the assumed observable satellite (step G3: Yes), the host CPU 20 determines whether or not differential ephemeris data at the current date corresponding to the assumed observable satellite is stored in the terminal ephemeris database 803 (step G5). When the host CPU 20 has determined that differential ephemeris data at the current date corresponding to the assumed observable satellite is stored in the terminal ephemeris database 803 (step G5: Yes), the host CPU 20 generates ephemeris data at the current date based on the reference ephemeris data determined in the step G1 and the differential ephemeris data at the current date determined in the step G5 (step G7).

The host CPU 20 then updates the reference ephemeris data stored in the terminal ephemeris database 803 with the ephemeris data generated in the step G7 (step G9). The host CPU 20 then transmits a request signal that requests the server 3 to transmit a differential predicted set (including the assumed observable satellite and the reference date) to the server 3 through the portable telephone antenna 50 and the portable telephone wireless communication circuit section 60 so that the reference ephemeris data updated in the step G9 is excluded (step G11).

The host CPU 20 then determines whether or not a differential predicted set has been received from the server 3 (step G13). When the host CPU 20 has determined that a differential predicted set has not been received from the server 3 (step G13: No), the host CPU 20 finishes the third ephemeris request process. When the host CPU 20 has determined that a differential predicted set has been received from the server 3 (step G13: Yes), the host CPU 20 updates the terminal ephemeris database 803 based on the received differential predicted set (step G15), and finishes the third ephemeris request process.

When the host CPU 20 has determined that the given time has not elapsed from the reference date of the assumed observable satellite in the step G3 (step G3: No), the host CPU 20 transmits a request signal that requests the server 3 to transmit a differential predicted set (including the assumed observable satellite and the reference date) to the server 3 through the portable telephone antenna 50 and the portable telephone wireless communication circuit section 60 (step G17).

The host CPU 20 then determines whether or not a differential predicted set has been received from the server 3 (step G19). When the host CPU 20 has determined that a differential predicted set has not been received from the server 3 (step G19: No), the host CPU 20 finishes the third ephemeris request process. When the host CPU 20 has determined that a differential predicted set has been received from the server 3 (step G19: Yes), the host CPU 20 updates the terminal ephemeris database 803 based on the received differential predicted set (step G21), and finishes the third ephemeris request process.

When the host CPU 20 has determined that the reference ephemeris data corresponding to the assumed observable satellite is not stored in the step G1 (step G1: No), or has determined that differential ephemeris data at the current date corresponding to the assumed observable satellite is not stored in the step G5 (step G5: No), the host CPU 20 transmits a request signal that requests the server 3 to transmit a reference-containing predicted set (including the assumed observable satellite and the current date) to the server 3 through the portable telephone antenna 50 and the portable telephone wireless communication circuit section 60 (step G23).

The host CPU 20 then determines whether or not a reference-containing predicted set has been received from the server 3 (step G25). When the host CPU 20 has determined that a reference-containing predicted set has not been received from the server 3 (step G25: No), the host CPU 20 finishes the third ephemeris request process. When the host CPU 20 has determined that a reference-containing predicted set has been received from the server 3 (step G25: Yes), the host CPU 20 updates the terminal ephemeris database 803 based on the received reference-containing predicted set (step G27), and finishes the third ephemeris request process.

5-6. Deletion of Prediction Process

In the portable telephone 2, old ephemeris data may be deleted from the terminal ephemeris database 803. Specifically, the portable telephone 2 acquires a reference-containing predicted set from the server 3, stores the reference-containing predicted set in the terminal ephemeris database 803, and deletes the ephemeris data older than the current date.

Although only some embodiments of the invention have been described in detail above, those skilled in the art would readily appreciate that many modifications are possible in the embodiments without materially departing from the novel teachings and advantages of the invention. Accordingly, such modifications are intended to be included within the scope of the invention.

What is claimed is:

1. A position calculation method implemented by a position calculation system that includes a position calculation device and a server, the position calculation device calculating its position by performing given positioning calculations based on navigation data that is positioning satellite orbit information, and the server providing navigation data to the position calculation device, the position calculation method comprising:
causing the position calculation device to store navigation data at a given reference date as reference navigation data corresponding to the reference date, transmit the reference date to the server to request the server to transmit latest differential navigation data that indicates a difference between the navigation data at the reference date and latest navigation data, receive the latest differential navigation data from the server, and calculate its position by performing the given positioning calculations based on the latest differential navigation data received from the server and the reference navigation data; and
causing the server to successively acquire latest navigation data from a positioning satellite or an external system, store the acquired navigation data, generate the latest differential navigation data based on navigation data at the reference date transmitted from the position calculation device and the latest navigation data included in the stored navigation data, and transmit the generated latest differential navigation data to the position calculation device.

2. A position calculation system comprising:
a position calculation device that calculates its position by performing given positioning calculations based on navigation data that is positioning satellite orbit information; and
a server that provides navigation data to the position calculation device,
the position calculation device including:
a storage section that stores navigation data at a given reference date as reference navigation data corresponding to the reference date;
a differential navigation data request section that transmits the reference date to the server to request the server to transmit latest differential navigation data that indicates a difference between the navigation data at the reference date and latest navigation data;
a reception section that receives the latest differential navigation data from the server; and
a position calculation section that calculates the position of the position calculation device by performing the given positioning calculations based on the latest differential navigation data received from the server and the reference navigation data; and
the server including:
a navigation data acquisition section that successively acquires latest navigation data from a positioning satellite or an external system;
a storage section that stores the acquired navigation data;
a latest differential navigation data generation section that generates the latest differential navigation data based on navigation data at the reference date transmitted from the position calculation device and the latest navigation data included in the stored navigation data; and
a transmission section that transmits the generated latest differential navigation data to the position calculation device.

3. A position calculation method comprising:
storing navigation data at a given reference date as reference navigation data corresponding to the reference date;
transmitting the reference date to a server that provides navigation data to request the server to transmit latest differential navigation data that indicates a difference between the navigation data at the reference date and latest navigation data;
receiving the latest differential navigation data from the server; and
calculating a position by performing given positioning calculations based on the latest differential navigation data received from the server and the reference navigation data.

4. The position calculation method as defined in claim 3, further comprising:
requesting the server to transmit navigation data at a current date by transmitting the current date to the server; and
updating the stored reference navigation data with navigation data transmitted from the server in response to the request that requests the latest navigation data, and updating the reference date corresponding to the reference navigation data with the current date.

5. The position calculation method as defined in claim 4, further comprising:
determining whether or not a time difference between the reference date of the stored reference navigation data and the current date has exceeded a given time,
the requesting including requesting the server to transmit the navigation data at the current date when it has been determined that the time difference has exceeded the given time.

6. The position calculation method as defined in claim 3,
the server including a navigation data prediction section that predicts navigation data corresponding to a given prediction period, and a predicted differential navigation data calculation section that calculates predicted differential navigation data that indicates a difference between the navigation data predicted by the navigation data prediction section and navigation data at a reference date transmitted from a position calculation device;
the storing including storing the predicted differential navigation data corresponding to the prediction period of the predicted differential navigation data;
the method further comprising determining whether or not navigation data or predicted differential navigation data at a current date is stored;
the requesting including transmitting the current date to the server to request the server to transmit the latest differential navigation data and predicted differential navigation data corresponding to the prediction period when it has been determined that navigation data or predicted differential navigation data corresponding to the current date is not stored; and
the method further comprising storing the latest differential navigation data and the predicted differential navigation data transmitted from the server in response to the request when it has been determined that navigation data or predicted differential navigation data corresponding to the current date is not stored.

7. The position calculation method as defined in claim 3,
the storing including storing the reference navigation data corresponding to the reference date of the reference navigation data for each positioning satellite; and
the requesting including requesting the server to transmit the latest differential navigation data corresponding to each positioning satellite.
